(19) United States
(12) Patent Application Publication
(10) Pub. No.: US 2018/0263843 A1
(43) Pub. Date: Sep. 20, 2018

(54) MASSAGING DEVICE HAVING DETACHABLE SHIELD

(71) Applicant: Paul CHEN, Vancouver (CA)

(72) Inventor: Paul CHEN, Vancouver (CA)

(21) Appl. No.: 15/459,077

(22) Filed: Mar. 15, 2017

(51) Int. Cl. A61H 15/02; A61H 15/00

(52) U.S. Cl. CPC A61H 15/02; A61H 15/0092; A61H 2015/0014; A61H 2201/0107; A61H 2201/0207

(57) ABSTRACT

A massaging device includes a handle device attached to an inner member, and a shield detachably attached onto the inner member for covering and protecting the inner member. The handle device includes a handle member having a projection for engaging with the inner member. The handle member includes a cushion attached onto a shank. The shield includes two barrels attached onto the inner member. The barrels each include an inner sleeve engaged with the inner member, and an outer housing engaged with the inner sleeve. The inner sleeves each include an outer thread, and the outer housings each include an inner thread for engaging with the outer thread of the inner sleeve and for detachably attaching the outer housing to the inner sleeve respectively.

### BACKGROUND OF THE INVENTION

### 1. Field of the Invention

The present invention relates to a massaging device, and more particularly to a massaging device including an outer protective cover or shield for containing and shielding a heated or cooled member and for preserving the heat or the cooling temperature of the heated or cooled member in order to comfortably heat or cool and massage the user.

### 2. Description of the Prior Art

Typical massaging devices comprise a relatively harder or stronger inner housing, and a relatively softer or resilient outer layer for selectively contacting or engaging with the users and for massaging purposes.

For example, U.S. Pat. No. 4,807,603 to Yasui discloses one of the typical massaging devices also comprising a relatively harder or stronger inner housing having a cylindrical shape or contour or structure, and a relatively softer or resilient outer layer for selectively contacting or engaging with the users and for massaging purposes.

However, the typical massaging devices include a solid structure or configuration having no heated or cooled member and for providing the heat or the cooling temperature of the heated or cooled member to heat or cool and massage the user.

U.S. Pat. No. 8,888,808 to Park discloses another typical massaging device comprising a planar base member having a number of projections or protrusions extended outwardly therefrom for frictionally contacting or engaging with the users and for massaging purposes.

However, similarly, the typical massaging devices also include a solid structure or configuration having no heated or cooled member and for providing the heat or the cooling temperature of the heated or cooled member to heat or cool and massage the user.

The present invention has arisen to mitigate and/or obviate the afore-described disadvantages of the conventional massaging devices.

### SUMMARY OF THE INVENTION

The primary objective of the present invention is to provide a massaging device including an outer protective cover or shield for containing and shielding a heated or cooled member and for preserving the heat or the cooling temperature of the heated or cooled member in order to comfortably heat or cool and massage the user.

In accordance with one aspect of the invention, there is provided a massaging device comprising an inner member, a handle device attached to the inner member, and a shield detachably attached onto the inner member for covering and protecting the inner member, the shield is made of a relatively softer or resilient material, such as plastic, synthetic materials, rubber or the like for softly and comfortably contacting or engaging with the users and for massaging purposes. The inner member may be heated to a relatively higher temperature for heating and massaging the user, or may be cooled to a relatively lower or freezing temperature for cooling and massaging the user.

The inner member includes a cavity formed therein, and the handle device includes a handle member having a projection extended from the handle member for engaging with the cavity of the inner member and for detachably attaching the handle member to the inner member with such as a force-fitted engagement or the like.

The handle member includes a shank, and a cushion attached onto the shank, the projection is extended from the shank for engaging with the inner member. The inner member includes an outer diameter greater than that of the handle member for forming a peripheral rib or flange between the inner member and the handle member.

The shield includes two barrels detachably attached onto the inner member. The barrels each include a compartment formed therein for receiving and engaging with the inner member. The barrels each include a peripheral protrusion extended radially and inwardly into the compartment for engaging with the inner member and for anchoring and positioning the barrels to the inner member selectively.

The barrels each include an inner sleeve having the compartment formed in the inner sleeve for engaging with the inner member, and an outer housing engaged with the inner sleeve. The inner sleeves each include an outer thread provided thereon, and the outer housings each include an inner thread formed therein for threading and engaging with the outer thread of the inner sleeve and for detachably attaching the outer housing to the inner sleeve respectively.

The outer housings each include a rib extended radially and inwardly therefrom, and the inner sleeves each include an outer peripheral groove formed therein for engaging with the peripheral rib of the outer housing and for retaining the outer housing to the inner sleeve respectively.

A first of the inner sleeves includes an inner diameter greater than an outer diameter of an inner end portion of a second of the sleeves for allowing the inner end portion of the second sleeve to be engaged into the compartment of the first sleeve. A first of the barrels includes a lock slot formed therein, and a second of the barrels includes a tongue extended therefrom for engaging with the lock slot of the first barrel and for detachably securing the barrels onto the inner member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a massaging device in accordance with the present invention;

FIG. 2 is a cross sectional view of the massaging device, taken along lines 2-2 of FIG. 1;

FIG. 3 is a partial exploded view of the massaging device;

FIG. 4 is another exploded view of the massaging device, as seen from one direction of the massaging device;

FIG. 5 is a further exploded view of the massaging device, as seen from the other direction of the massaging device; and

FIG. 6 is an exploded view of the massaging device.

### DETAILED DESCRIPTION OF THE PREFERRED EMBODIMENT

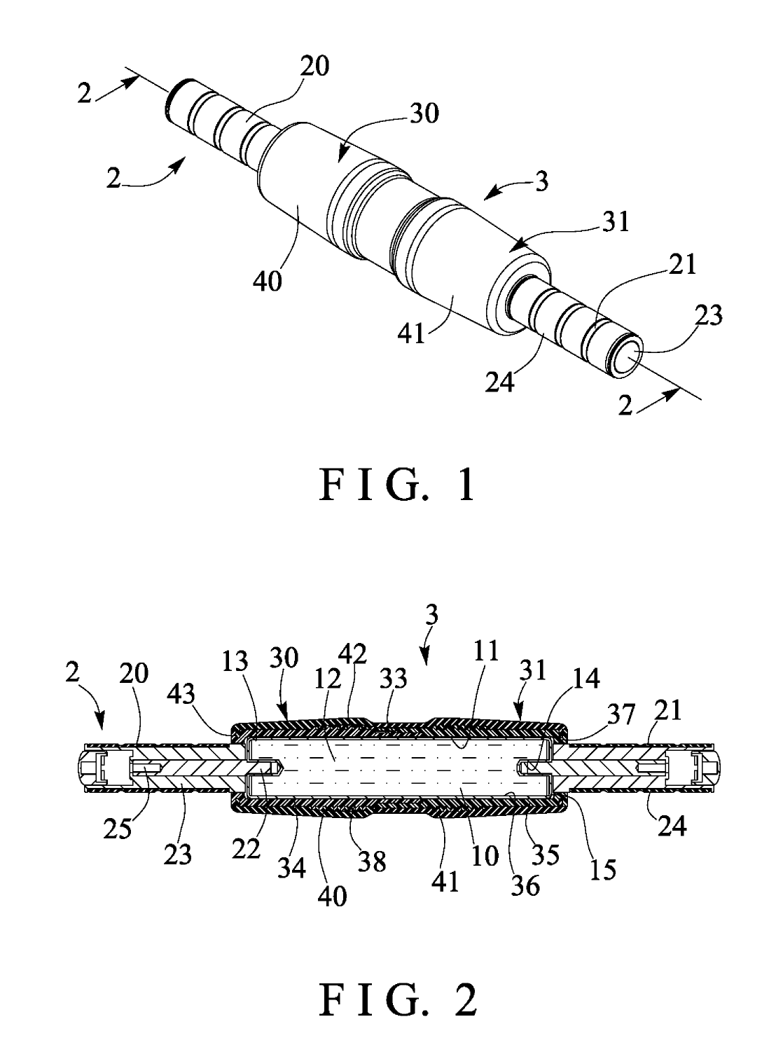

Referring to the drawings, and initially to FIGS. 1-3, a massaging device in accordance with the present invention comprises a core or inner member 10 made of a relatively stronger material, such as plastic, metal materials, composite materials or the like which may be heated with an heater, microwave over (not illustrated) or the like, and/or cooled with a refrigerator (not illustrated) or the like; i.e., the inner member 10 may be heated to a relatively higher temperature for heating and massaging the user, or may be cooled to a relatively lower temperature for cooling and massaging the user. The inner member 10 may include a solid structure or configuration, or may include a hollow structure or configuration having a compartment or bore or chamber 11 formed therein for receiving or containing a water or fluid or heat medium 12 therein.

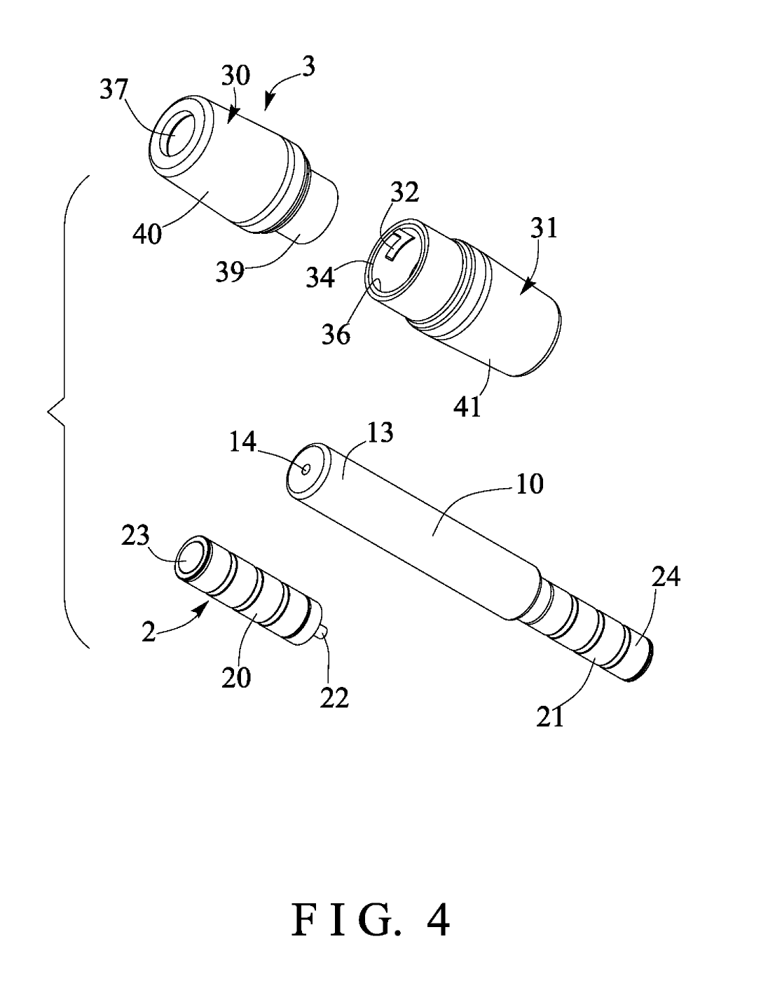

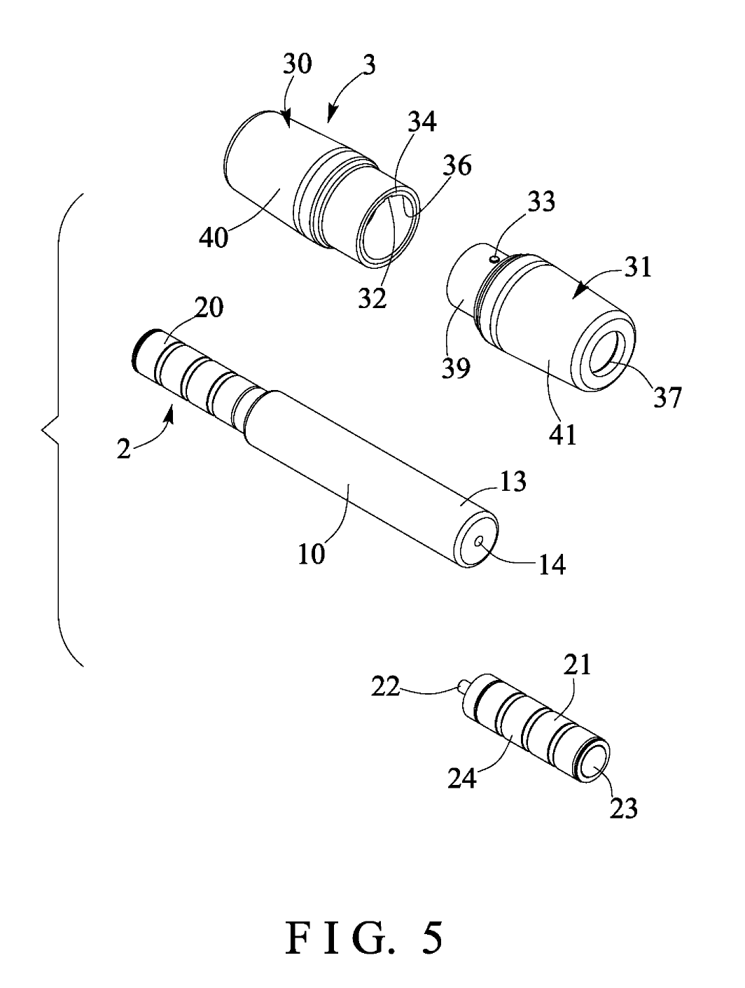

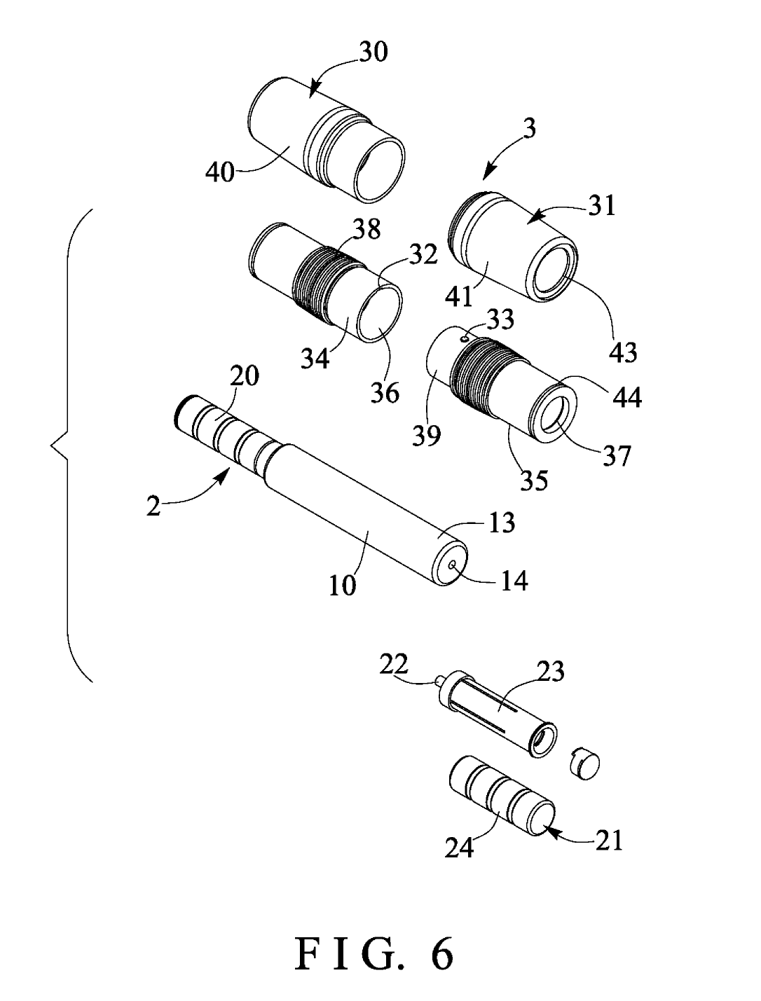

A handle device 2 includes one or more (such as two) handle members 20, 21 selectively or optionally provided and detachably or changeably attached or mounted or secured to either or both of the end portions 13 of the inner member 10. For example, the inner member 10 includes a hole or cavity 14 formed in each of the end portions 13 thereof (FIGS. 4-6), and the handle members 20, 21 each include a peg or projection 22 extended axially and outwardly therefrom for engaging with either of the cavities 14 of the inner member 10 and for detachably or changeably attached or mounted or secured to the inner member 10 with a force-fitted engagement or the like. As shown in FIGS. 2 and 6, the handle members 20, 21 each include a solid structure or configuration, or each may include a barrel or shank 23 having the projection 22 extended therefrom, and an outer cover or cushion 24 attached or mounted or secured onto the shank 23.

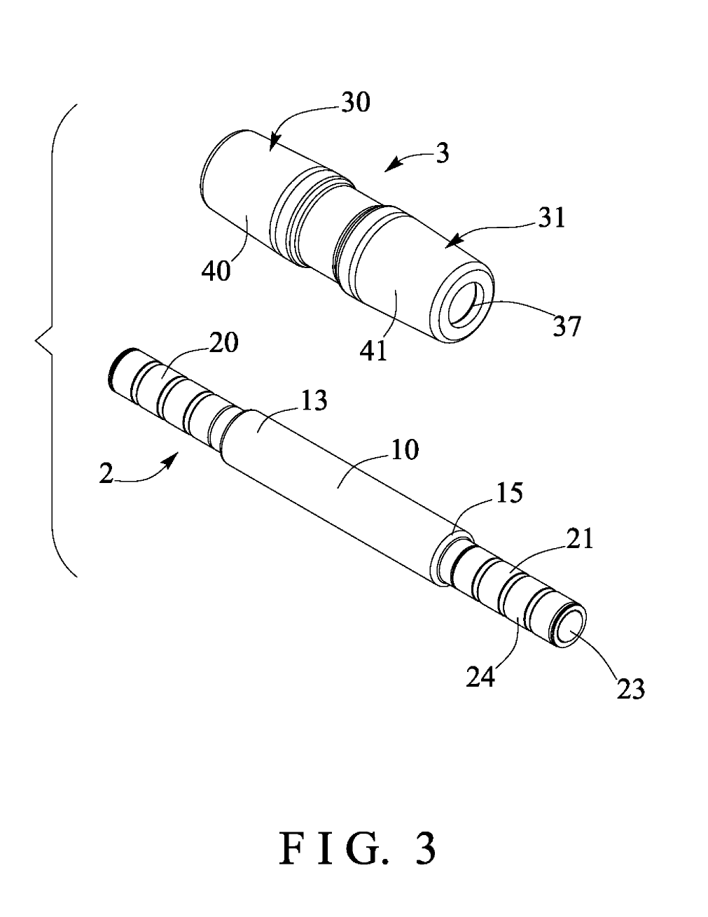

It is preferable, but not necessary that the shank 23 is made of a relatively stronger material, such as plastic, metal materials, composite materials or the like, and the outer cushion 24 is made of a relatively softer or resilient material, such as plastic, synthetic materials, rubber or the like for softly and comfortably contacting or engaging with the users, and arranged for allowing the user to solidly and stably grasp or hold the handle members 20, 21 and the inner member 10, and/or for easily and readily moving and engaging the inner member 10 with the users, and for massaging purposes. As shown in FIG. 2, the projection 22 may be selected from a rod or the like disengaged or separated from the shank 23, and attached or mounted or secured to the shank 23 with welding procedures, adhesive materials, latches or fasteners 25 or the like. The inner member 10 includes an outer diameter greater than that of the handle members 20, 21 for forming or defining a peripheral rib or flange 15 between the inner member 10 and the handle members 20, 21 (FIGS. 2, 3).

The massaging device in accordance with the present invention further includes an outer protective cover or shield 3 for detachably or changeably attaching or mounting or securing onto the inner member 10 and for covering or protecting or shielding the inner member 10 selectively or optionally, and for preventing the inner member 10 from contacting or engaging with the users directly, and for preventing the users from being heated by the heated inner member 10 that may be over-heated or that may include a relatively higher temperature; or alternatively, for preventing the users from being cooled by the cooled inner member 10 that may include a relatively lower or freezing temperature. For example, the protective shield 3 includes two tubular members or barrels 30, 31 arranged to be detachably or changeably attached or mounted or secured onto the inner member 10.

For example, the one or first of the barrels 30 includes a lock slot 32, such as an L-shaped slot 32 formed therein (FIG. 4), and the other or second barrel 31 includes a lock key or tongue 33 extended therefrom (FIGS. 2, 5-6) for selectively engaging with the lock slot 32 of the first barrel 30, and thus for detachably or changeably attaching or mounting or securing the protective shield 3 onto the inner member 10. As shown in FIGS. 2 and 4-6, the barrels 30 of the shield 3 each include an inner sleeve 34, 35 formed or provided therein and made of a relatively stronger material, such as plastic, composite materials or the like, and the sleeve 34, 35 each include an inner chamber or bore or compartment 36 formed therein for receiving or containing or engaging with the inner member 10, and each include a peripheral rib or protrusion 37 extended radially and inwardly into the compartment 36 of the sleeve 34, 35.

For example, the peripheral protrusion 37 of the sleeve 34, 35 may be contacted or engaged with the peripheral flange 15 that is formed between the inner member 10 and the handle members 20, 21 for anchoring or positioning or retaining the sleeve 34, 35 to the inner member 10. It is preferable that the sleeves 34, 35 each include an outer thread 38 formed or provided on the outer peripheral portion thereof. The one or inner end portion 39 of one of the sleeves 35 includes an outer diameter smaller than the inner diameter of the compartment 36 of the first sleeve 34 for allowing the inner end portion 39 of the second sleeve 35 to be engaged into the compartment 36 of the first sleeve 34. The tongue 33 of the other or second barrel 31 is formed or provided on the inner end portion 39 of the second sleeve 35, and the lock slot 32 of the first barrel 30 is formed or provided in the inner portion of the first sleeve 34.

The barrels 30 of the shield 3 each further include an outer pad or housing 40, 41 made of a relatively softer or resilient material, such as plastic, synthetic materials, rubber or the like for softly and comfortably contacting or engaging with the users. The outer housings 40, 41 each include an inner thread 42 formed therein (FIG. 2) for threading or engaging with the outer thread 38 of the sleeves 34, 35 and for detachably or changeably attaching or mounting or securing the outer housings 40, 41 to the sleeves 34, 35 respectively. It is preferable that the outer housings 40, 41 each include a peripheral swelling or rib 43 extended radially and inwardly therefrom (FIG. 2), and the sleeves 34, 35 each include an outer peripheral slot or groove 44 formed therein (FIG. 6) for receiving or engaging with the peripheral rib 43 of the outer housings 40, 41 and for further solidly and stably anchoring or positioning or retaining the outer housings 40, 41 to the sleeves 34, 35 respectively.

In operation, as shown in FIG. 3, the inner member 10 may be provided for selectively contacting or engaging with the users directly and for massaging purposes. As shown in FIGS. 1 and 2, the barrels 30 of the shield 3 may also be detachably or changeably attached or mounted or secured onto the inner member 10 for selectively contacting or engaging with the users and for massaging purposes. When the barrels 30 of the shield 3 are engaged onto or with the inner member 10 in order to cover or protect or shield the inner member 10 selectively or optionally, the inner member 10 may be prevented from contacting or engaging with the users directly, for preventing the users from being heated by the heated inner member 10 that may be over-heated or that may include a relatively higher temperature; or alternatively, for preventing the users from being cooled by the cooled inner member 10 that may include a relatively lower or freezing temperature. The temperature of the inner member 10 may be preserved and kept for a longer time interval with the barrels 30 of the shield 3.

Accordingly, the massaging device in accordance with the present invention includes an outer protective cover or shield for containing and shielding a heated or cooled member and for preserving the heat or the cooling temperature of the heated or cooled member in order to comfortably heat or cool and massage the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A massaging device comprising:
an inner member;
a handle device attached to said inner member; and
a shield detachably attached onto said inner member for covering and protecting said inner member.

2. The massaging device as claimed in claim 1, wherein said inner member includes a cavity formed therein, and said handle device includes a handle member having a projection extended from said handle member for engaging with said cavity of said inner member and for detachably attaching said handle member to said inner member.

3. The massaging device as claimed in claim 2, wherein said handle member includes a shank, and a cushion attached onto said shank, said projection is extended from said shank.

4. The massaging device as claimed in claim 2, wherein said inner member includes an outer diameter greater than that of said handle member for forming a peripheral flange between said inner member and said handle member.

5. The massaging device as claimed in claim 1, wherein said shield includes two barrels attached onto said inner member.

6. The massaging device as claimed in claim 5, wherein said barrels each include a compartment formed therein for receiving and engaging with said inner member.

7. The massaging device as claimed in claim 6, wherein said barrels each include a peripheral protrusion extended radially and inwardly into said compartment for engaging with said inner member.

8. The massaging device as claimed in claim 6, wherein said barrels each include an inner sleeve having said compartment formed in said inner sleeve for engaging with said inner member, and an outer housing engaged with said inner sleeve.

9. The massaging device as claimed in claim 8, wherein said inner sleeves each include an outer thread provided thereon, and said outer housings each include an inner thread formed therein for threading and engaging with said outer thread of said inner sleeve and for detachably attaching said outer housing to said inner sleeve respectively.

10. The massaging device as claimed in claim 8, wherein said outer housings each include a rib extended radially and inwardly therefrom, and said inner sleeves each include an outer peripheral groove formed therein for engaging with said peripheral rib of said outer housing and for retaining said outer housing to said inner sleeve respectively.

11. The massaging device as claimed in claim 8, wherein a first of said inner sleeves includes an inner diameter greater than an outer diameter of an inner end portion of a second of said sleeves for allowing said inner end portion of said second sleeve to be engaged into said compartment of said first sleeve.

12. The massaging device as claimed in claim 5, wherein a first of said barrels includes a lock slot formed therein, and a second of said barrels includes a tongue extended therefrom for engaging with said lock slot of said first barrel and for detachably securing said barrels onto said inner member.

13. The massaging device as claimed in claim 1, wherein said inner member includes a chamber formed therein.

14. The massaging device as claimed in claim 13, wherein said inner member includes a cooling agent received and engaged in said chamber of said inner member.

15. The massaging device as claimed in claim 13, wherein said inner member includes a heating agent received and engaged in said chamber of said inner member.
